(19) United States
(12) Patent Application Publication
(10) Pub. No.: US 2016/0132620 A1
(43) Pub. Date: May 12, 2016

(54) METHOD FOR PROCESS MODELING AND COMPUTER READABLE STORAGE MEDIUM FOR STORING THE METHOD

(71) Applicant: INSTITUTE FOR INFORMATION INDUSTRY, Taipei (TW)

(72) Inventors: Ko-Yang Wang, Taipei City (TW); Chi-Hung Tsai, Taipei City (TW); Sheng-Po Tseng, Hsinchu City (TW)

(21) Appl. No.: 14/558,791

(22) Filed: Dec. 3, 2014

(30) Foreign Application Priority Data
Nov. 7, 2014 (TW) 103138750

(51) Int. Cl. G06F 17/50

(52) U.S. Cl. CPC G06F 17/5009

(57) ABSTRACT

A method for process modeling includes to set a final output of a process as a key artifact. Then, activities are sequentially generated according to the key artifact. That is, the key artifact acts as a starting point. The activities are sequentially generated from the starting point, the key artifact, to form the process.

### RELATED APPLICATIONS

This application claims priority to Taiwan Application Serial Number 103138750, filed Nov. 7, 2014, the entirety of which is herein incorporated by reference.

### BACKGROUND

1. Field of Invention

The invention relates to a modeling method, and particularly relates to a process modeling method and computer readable storage medium for storing the method.

2. Description of Related Art

The contemporary business operations are encountering challenges. The management of the globalization, such as the supply chain management, makes the enterprise to consider making alliances, establishing the partner relationships. At this time, when an enterprise wants to sustain a competitive advantage, a business process with adaptation and facilitation to support the operations of the organization is necessary. Therefore, a good process modeling method can improve the value of an enterprise. Process modeling is a technology that can systematize a business process and use diagram to represent the business process to manage.

Typically, a business process is composed of many enterprise activities. When a process modeling is performed, an enterprise activity acts as a starting point to deduced the relevant activities to form a process. That is, these relevant activities are listed, and then, these activities are linked together to form the process. Because the process is developed from the enterprise activities, the consideration focus on how to group these enterprise activities to form the process, which increase the difficulty to integrate the activities in different processes. The listed activities often include redundancy activities. For removing the redundancy activities, an additional optimization of process is needed, which increases the total time cost for process modeling. Besides, when it comes to the division of work, departmental selfishness may lead to some obstructions of optimization. On the other hand, the content of the activities and process has to be ensured when the process is developed, therefore, it is very difficult to adjust the content after the process modeling is finished, which further increases the difficulty to optimize the process.

Therefore, there is a need for a process modeling method to decrease the optimizing process requirement to accelerate the process modeling, and to generate an optimization process.

### SUMMARY

Accordingly, the invention provides a method for process modeling. First, a final output of a process is set as a key artifact. Then, activities are sequentially generated according to the key artifact. The key artifact is a starting point. The activities are sequentially generated from the starting point, the key artifact, to form the process.

The present invention also provides a method for process modeling. First, a final output of a process is set as a key artifact. Next, activities are sequentially generated according to the key artifact. The key artifact is a starting point. The activities are sequentially generated from the starting point, the key artifact, to form the process. Then, the activities are grouped according to the outputs. Next, the activities are assigned to relevant parties. Finally, The activities are grouped according to the relevant parties to accomplish the process.

Accordingly, a final output of the process is set as a deduction starting point. Activities relevant to a process are sequentially deduced from the deduction starting point, to form the process. Because the activities are deduced from the final output of the process, these activities are very related to generate the final output. Therefore, the necessary of optimizing the process is reduced.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 illustrates a flow chart of a process modeling method for an enterprise according to an embodiment of the invention;

FIG. 2A illustrates a schematic diagram for deducing a process in accordance with an annual turnover of an enterprise according to an embodiment of the invention;

FIG. 2B illustrates a schematic diagram for decomposing the “construction work” activity in FIG. 2A into multiple sub-activities according to an embodiment of the invention;

FIG. 2C illustrates a schematic diagram for grouping the activities in FIG. 2A and FIG. 2B in accordance with the output of activities according to an embodiment of the invention;

FIG. 2D illustrates a schematic diagram for assigning the activities to relevant parties in an enterprise in accordance with their rights and responsibilities according to an embodiment of the invention;

FIG. 2E illustrates a schematic diagram for grouping the activities in FIG. 2D in accordance with the relevant parties according to an embodiment of the invention;

FIG. 3A illustrates a schematic diagram for deducing a process in accordance with an annual number of people in courses according to an embodiment of the invention;

FIG. 3B illustrates a schematic diagram for decomposing the “preparing course” activity in FIG. 3A into multiple sub-activities according to an embodiment of the invention;

FIG. 3C illustrates a schematic diagram for grouping the activities in FIG. 3A and FIG. 3B in accordance with the output of activities according to an embodiment of the invention;

FIG. 3D illustrates a schematic diagram for assigning the activities to relevant parties in an enterprise in accordance with their rights and responsibilities according to an embodiment of the invention; and

FIG. 3E illustrates a schematic diagram for grouping the activities in FIG. 3D in accordance with the relevant parties according to an embodiment of the invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

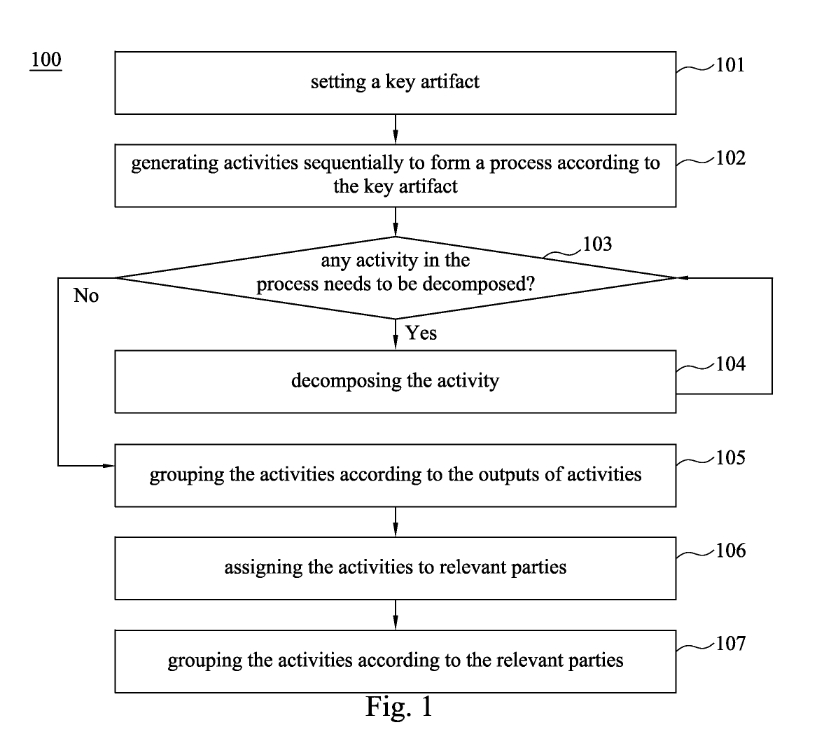

FIG. 1 illustrates a flow chart of a process modeling method for an enterprise according to an embodiment of the invention. According to the process modeling 100, a key artifact is set in step 101 first. Typically, a process is composed of many activities. However, in a traditional process modeling method, the final goal of the process is set as the deduction destination, and an activity is set as a deduction starting point. Then, activities relevant to the process are sequentially deduced from the starting activity to the goal to form the process. Therefore, in this traditional process deduction method, the consideration focus is how to deduce other activities from the starting activity to form the process. Because of always focusing on the activities, it often leads that an activity and its output within a process are very hard to link or integrate to another activity and its output in another process. That is, it is very difficult for activities in different processes to be integrated together. Moreover, after a process is formed, it is also very difficult to adjust the items in the process. Therefore, a goal-oriented process modeling method is developed in the present invention. According to the method, the final goal of the process is set as a deduction starting point. Activities relevant to a process are sequentially deduced from the deduction starting point, the final goal, to form the process. Therefore, the output of a process, the goal of a process, is set as a key artifact. All the activities in a process are generated for accomplishing the key artifact, the goal. In other words, the claimed invention changes the traditional process modeling method of from a starting activity to sequentially deduce the relevant activities to form a process to a goal-oriented process modeling method of from the key artifact, the final goal, to sequentially deduce the relevant activities to form a process. The process modeling method may take the form of a computer program product stored on a computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate random access memory (DDR-RAM); optical storage devices such as compact disc read only memories (CD-ROMs) and digital versatile disc read only memories (DVD-ROMs); and magnetic storage devices such as hard disk drives (HDD) and floppy disk drives. In an embodiment, a building enterprise set an annual turnover goal of 1 million dollars. That is, all the activities of the enterprise are for achieving the set annual turnover goal. Therefore, the turnover is the final output of the activity of the enterprise. According to the final output, the “revenue” is set as a key artifact. In another embodiment, an enterprise set an annual goal of number of students of 1000. That is, all activities of the enterprise are to output a special number of students. Therefore, the number of students is the final output of the activity of the enterprise. According to the final output, the “name list” is set as a key artifact.

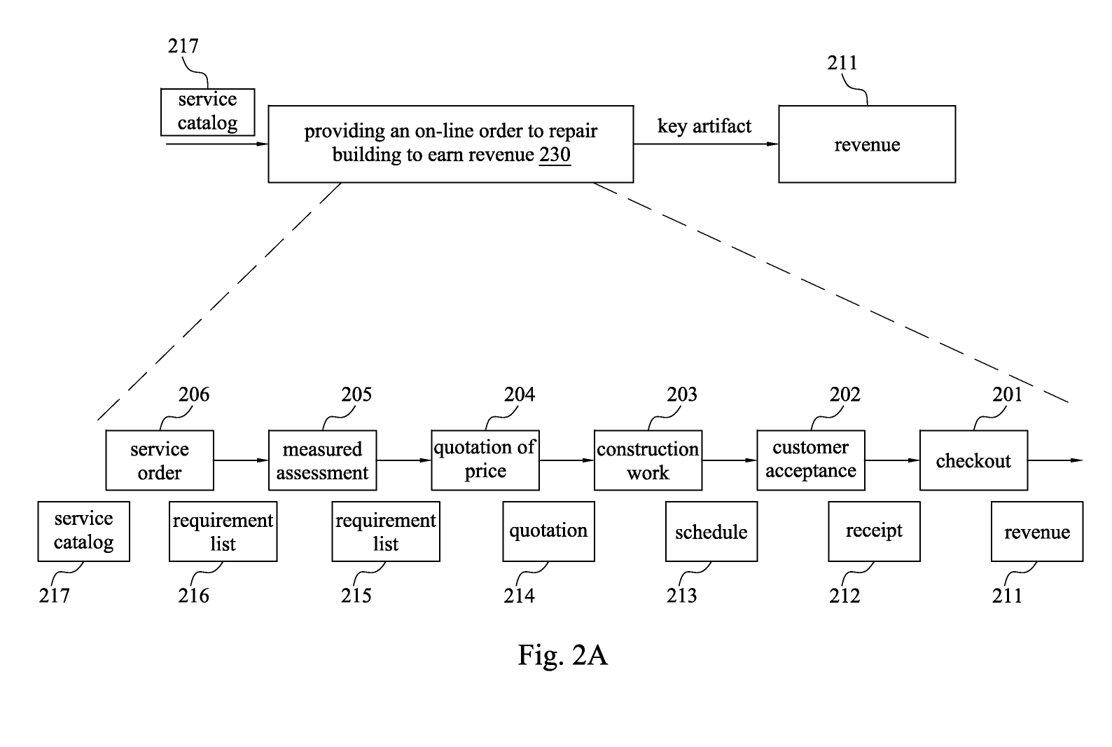

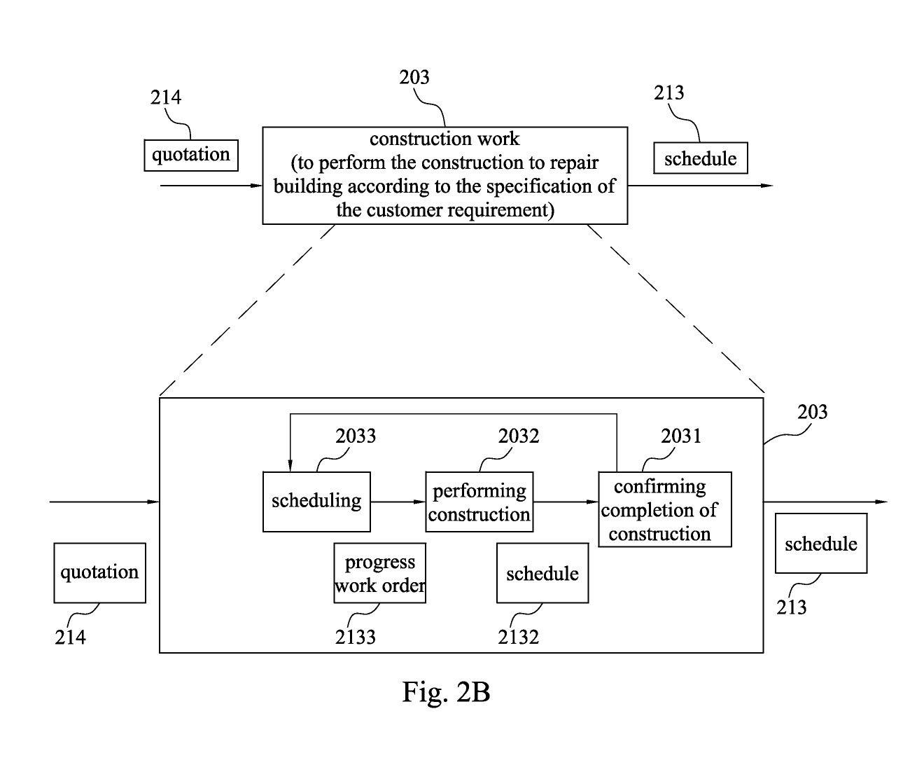

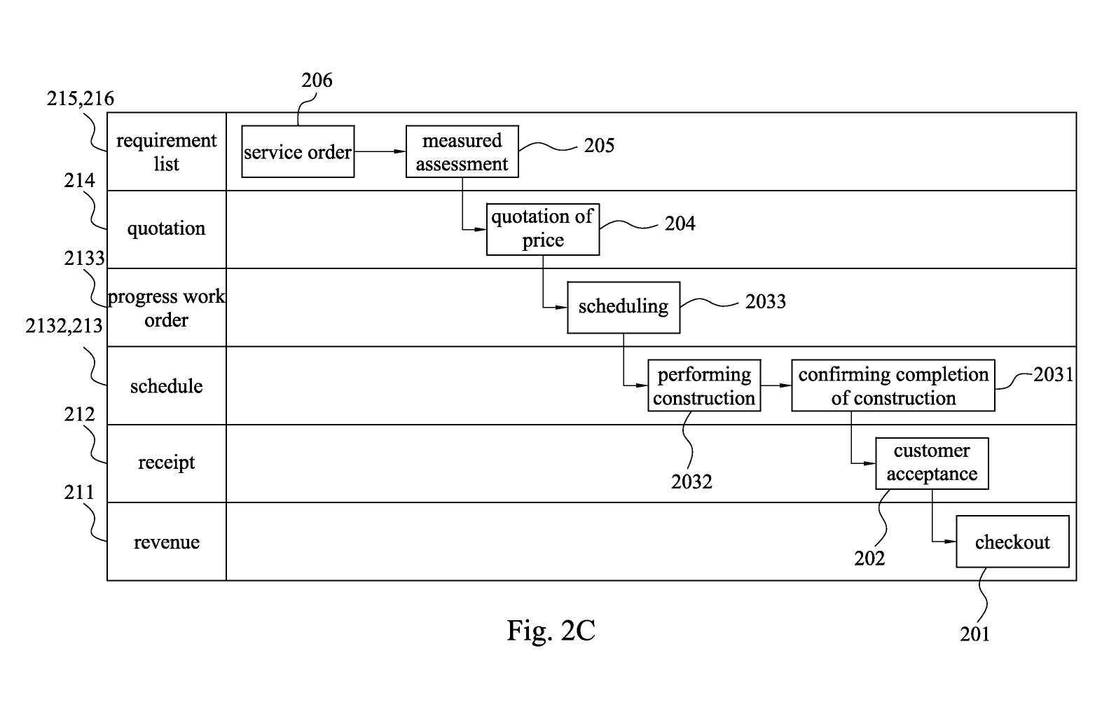

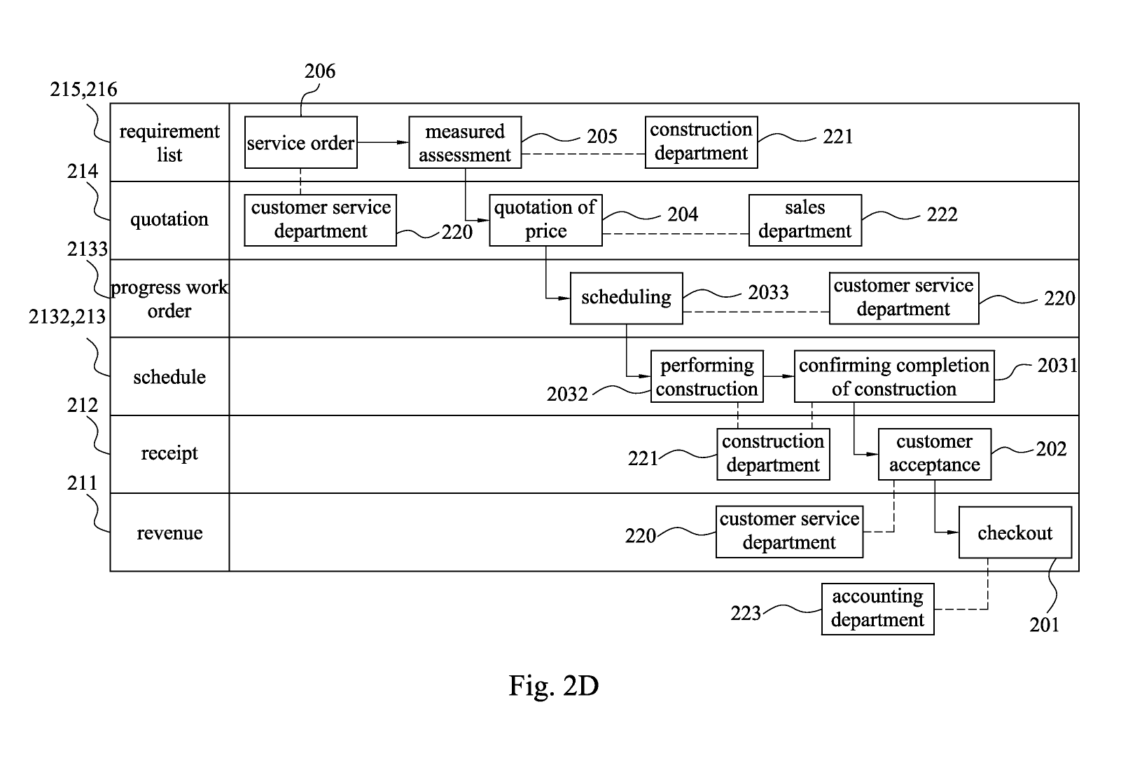

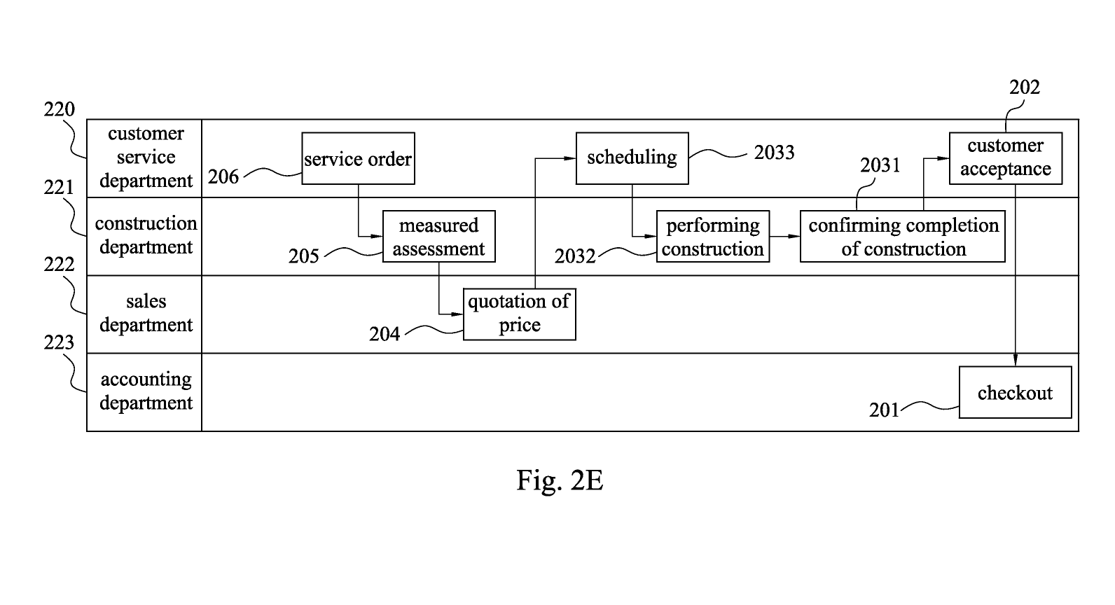

Next, in step 102, a process is designed. According to the final output, the key artifact, relevant activities are sequentially deduced from the key artifact to form a process. In an embodiment, the key artifact is the “revenue” . Therefore, the key artifact, the “revenue”, is analyzed to sequentially deduce relevant activities from the key artifact to form a process. FIG. 2A illustrates a schematic diagram for deducing a process in accordance with an annual turnover of an enterprise according to an embodiment of the invention. First, a process requirement description 230 is represented to describe the process requirement for realizing the key artifact, the “revenue” 211. Then, a process is designed according to the process requirement description 230. For example, the process requirement description 230 is to provide an online order service to repair building to earn revenue. Therefore, the “revenue” 211 is the final output of the process. The “service catalog” 217 is the input of the process. Accordingly, a “checkout” activity 201 is performed for realizing the output of the “revenue” 211. Before the “checkout” activity 201 is performed, a “customer acceptance” activity 202 is needed to output a “receipt” 212 to the customer to sign. The “receipt” 212 is provided to the “checkout” activity 201 to output the “revenue” 211. Before the “customer acceptance” activity 202 is performed, a “construction work” activity 203 is needed to output a “schedule” 213 to represent the construction schedule. The “schedule” 213 is provided to the “customer acceptance” activity 202 to output the “receipt” 212. Before the “construction work” activity 203 is performed, a “quotation of price” activity 204 is needed to output a “quotation” 214 to represent the price for customers. The “quotation” 214 is provided to the “construction work” activity 203 to generate the items in the “schedule” 213. Before the “quotation of price” activity 204 is performed, a “measured assessment” activity 205 is needed to output a “requirement list” 215 to explain the measurement for customers. The “requirement list” 215 is provided to the “quotation of price” activity 204 to generate the items in the “quotation” 214. Before the “measured assessment” activity 205 is performed, a “service order” activity 206 is needed to output a “requirement list” 216 to represent the items of repairing the house. The “requirement list” 216 is provided to the “measured assessment” activity 205 to generate the “requirement list” 215. Accordingly, the “checkout” activity 201, the “customer acceptance” activity 202, the “construction work” activity 203, the “quotation of price” activity 204, the “measured assessment” activity 205 and the “service order” activity 206 are sequentially deduced from the key artifact, the “revenue” 211, to form the process.

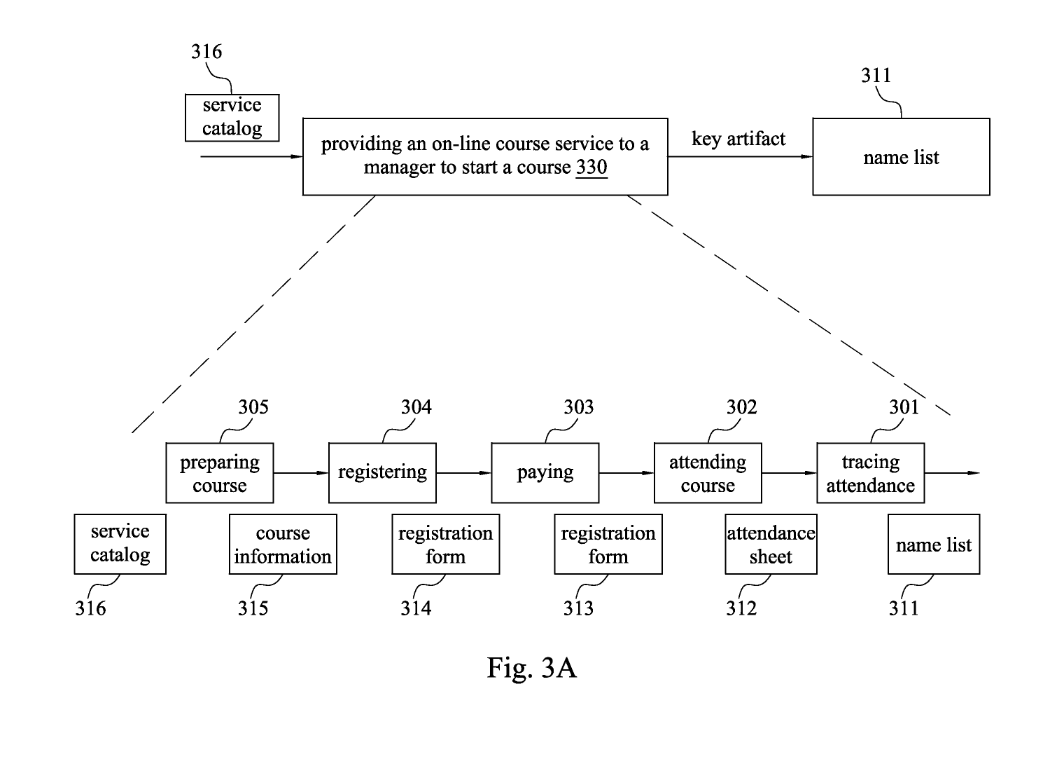

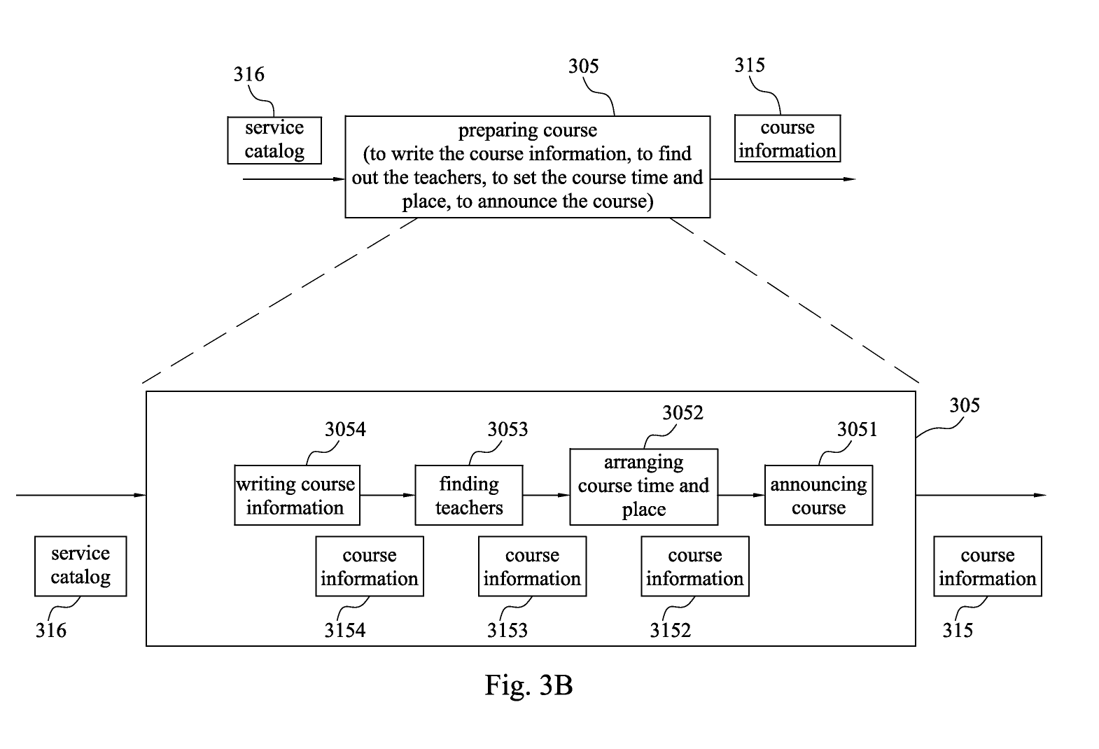

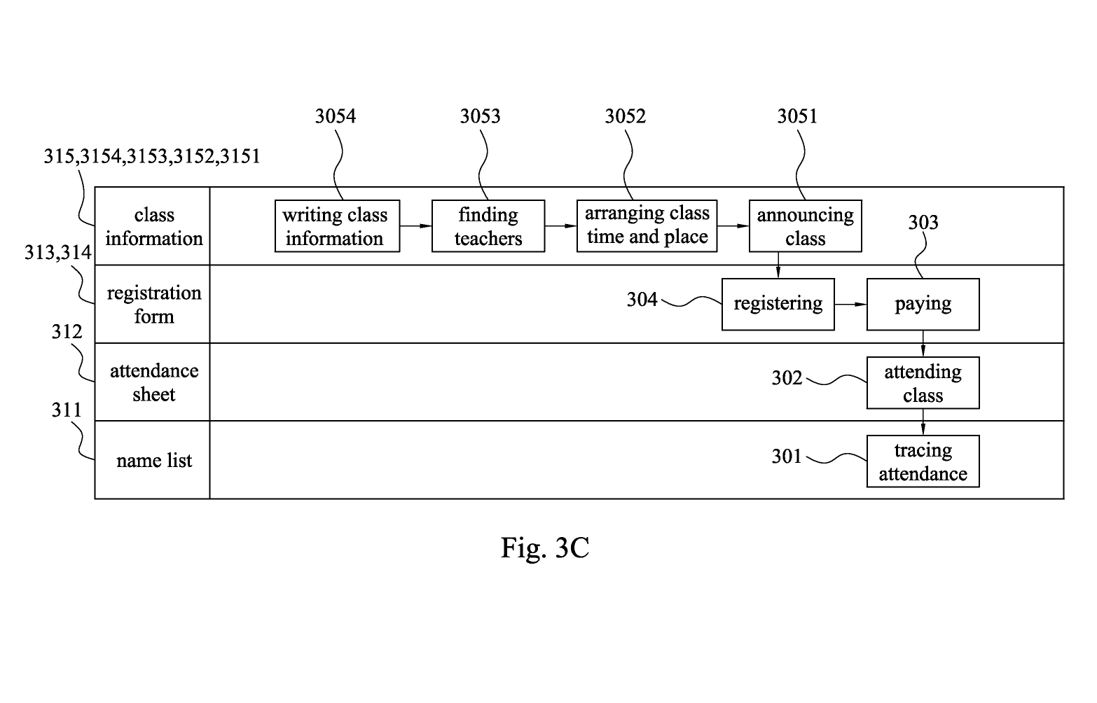

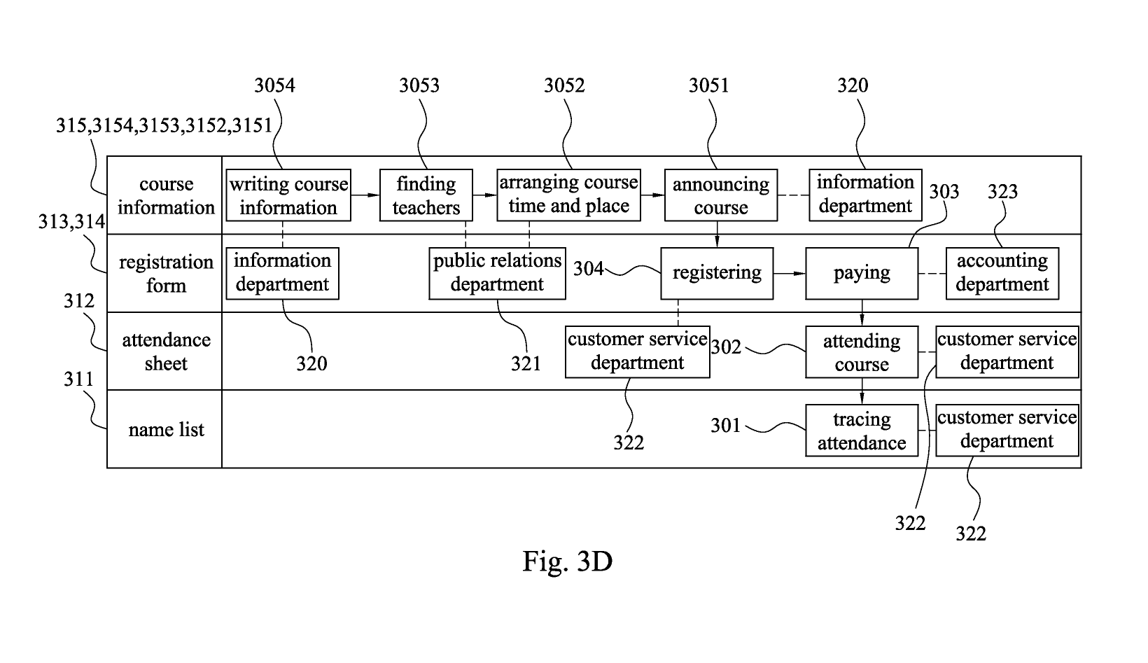

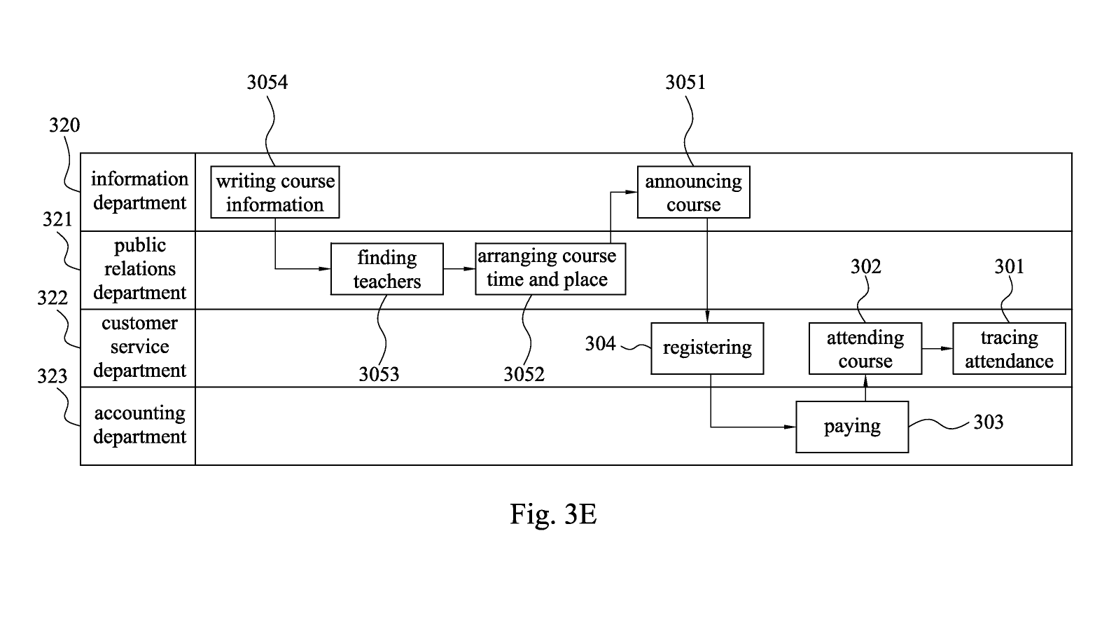

In another embodiment, the key artifact is the “name list” . Therefore, the key artifact, the “name list” , is analyzed to sequentially deduce relevant activities from the key artifact to form a process. FIG. 3A illustrates a schematic diagram for deducing a process in accordance with an annual number of people in courses according to an embodiment of the invention. First, a process requirement description 330 is represented to describe the process requirement for realizing the key artifact, the “name list” 311. Then, a process is designed according to the process requirement description 330. For example, the process requirement description 330 is to provide an on-line course service to a manager to start a course. Therefore, the “name list” 311 is the final output of the process. The “service catalog” 316 is the input of the process. Accordingly, a “tracing attendance” activity 301 is performed for realizing the output of the “name list” 311. Before the “tracing attendance” activity 301 is performed, a “attending course” activity 302 is needed to output an “attendance sheet” 312 to represent the attendance. The “attendance sheet” 312 is provided to the “tracing attendance” activity 301 to output the “name list” 311. Before the “attending course” activity 302 is performed, a “paying” activity 303 is needed to output a “registration form” 313 to represent the people who have paid. The “registration form” 313 is provided to the “attending course” activity 302 to output the “attendance sheet” 312 to represent the people who have to attend to the course. Before the “paying” activity 303 is performed, a “registering” activity 304 is needed to output a “registration form” 314 to represent the people who have registered the course. The “registration form” 314 is provided to the “paying” activity 303 to represent the people who have to pay the tuition. Before the “registering” activity 304 is performed, a “preparing course” activity 305 is needed to output a “course information” 315 to give a course statement for students to attract them to sign up. The “course information” 315 is provided to the “registering” activity 304 to generate the “registration form” 314. The “service catalog” 316 is provided to the “preparing course” activity 305 to generate the “course information” 315. Accordingly, the “tracing attendance” activity 301, the “attending course” activity 302, the “paying” activity 303, the “registering” activity 304 and the “preparing course” activity 305 are sequentially deduced from the key artifact, the “name list” 311, to form the process.

In step 103, a determination step is performed to determine the process whether or not needs to be decomposed again. That is to determine an activity whether or not needs to be decomposed to sub-activities. The sub-activities can be formed a sub-process of the process. When the process needs to be decomposed again, that is, an activity needs to be decomposed to sub-activities, the step 104 is performed to decompose this activity into sub-activities to form a sub-process of the process. The method described in the step 102 can be used here to decompose the activity. The output of this decomposed activity is set as the key artifact. The relevant sub-activities are sequentially deduced from the key artifact to form a sub-process. In an embodiment, if the “construction work” activity 203 in FIG. 2A needs to be decomposed to sub-activities, the step 104 is performed to decompose this “construction work” activity 203 into sub-activities to form a sub-process of the process. FIG. 2B illustrates a schematic diagram for decomposing the “construction work” activity in FIG. 2A into multiple sub-activities according to an embodiment of the invention. The “quotation” 214 is the input of the “construction work” activity 203. The “schedule” 213 is the output of the “construction work” activity 203. That is, the final output of the sub-process that is formed by decomposing the “construction work” activity 203 is the “schedule” 213. Therefore, the key artifact is the “schedule” 213 of the sub-process. The key artifact, the “schedule” 213, is analyzed first to sequentially deduce relevant sub-activities to form a sub-process. As step 102, a process requirement description is represented to describe the sub-process requirement for realizing the key artifact, the “schedule” 213. Then, the sub-process is designed according to the process requirement description. For example, the process requirement description is to perform the construction to repair building according to the specification of the customer requirement. Therefore, the “schedule” 213 is the final output of the process. The “quotation” 214 is the input of the process. Accordingly, a “confirming completion of construction” sub-activity 2031 is performed for realizing the output of the “schedule” 213. Before the “confirming completion of construction” sub-activity 2031 is performed, a “performing construction” sub-activity 2032 is needed to output a “schedule” 2132 to represent the items needs to be repaired. The “schedule” 2132 is provided to the “confirming completion of construction” sub-activity 2031 to output the “schedule” 213 to represent the item that has been repaired. Before the “performing construction” sub-activity 2032 is performed, a “scheduling” sub-activity 2033 is needed to output a “progress work order” 2133 to represent the construction progress. The “progress work order” 2133 is provided to the “performing construction” sub-activity 2032 to output the “schedule” 2132 to represent the construction schedule. The “quotation” 214 is provided to the “scheduling” sub-activity 2033 to generate the “progress work order” 2133. If the “confirming completion of construction” sub-activity 2031 determines that the construction is not finished, the “scheduling” sub-activity 2033 is performed again to generate the “progress work order” 2133. Accordingly, the “construction work” activity 203 is decomposed to the “confirming completion of construction” sub-activity 2031, the “performing construction” sub-activity 2032 and the “scheduling” sub-activity 2033. The “confirming completion of construction” sub-activity 2031, the “performing construction” sub-activity 2032 and the “scheduling” sub-activity 2033 are sequentially deduced from the key artifact, the “schedule” 213, to form the sub-process.

In another embodiment, if the “preparing course” activity 305 in FIG. 3A is determined to need to be decomposed to sub-activities, the step 104 is performed to decompose this “preparing course” activity 305 into sub-activities to form a sub-process of the process. FIG. 3B illustrates a schematic diagram for decomposing the “preparing course” activity in FIG. 3A into multiple sub-activities according to an embodiment of the invention. The “service catalog” 316 is the input of the “preparing course” activity 305. The “course information” 315 is the output of the “preparing course” activity 305. That is, the final output of the sub-process that is formed by decomposing the “preparing course” activity 305 is the “course information” 315. Therefore, the key artifact is the “course information” 315 of the sub-process. The key artifact, the “course information” 315, is analyzed first to sequentially deduce relevant sub-activities to form a sub-process. As step 102, a process requirement description is represented to describe the sub-process requirement for realizing the key artifact, the “course information” 315. Then, the sub-process is designed according to the process requirement description. For example, the process requirement description includes to write the course information, to find out the teachers, to set the course time and place and to announce the course to generate the “course information” 315. Therefore, relevant information including the “course information” 3154 of course name and statement, the “course information” 3153 of teachers, and the “course information” 3152 of course time and place is needed to generate the “course information” 315. The “course information” 3154 of course name and statement can be generated by the “writing course information” sub-activity 3054. The “course information” 3153 of teachers can be generated by the “finding teachers” sub-activity 3053. The “course information” 3152 of course time and place can be generated by the “arranging course time and place” sub-activity 3052. Then, the “course information” 315 is announced by the “announcing course” sub-activity 3051. The detailed step description does not be described here again. Accordingly, the “preparing course” activity 305 is decomposed to the “writing course information” sub-activity 3054, the “finding teachers” sub-activity 3053, the “arranging course time and place” sub-activity 3052 and the “announcing course” sub-activity 3051. The “writing course information” sub-activity 3054, the “finding teachers” sub-activity 3053, the “arranging course time and place” sub-activity 3052 and the “announcing course” sub-activity 3051 are sequentially deduced from the key artifact, the “preparing course” 315, to form the sub-process.

When no any activity in the process needs to be decomposed again in step 103, a step 105 is performed to group the activities according to the output of activities to represent the lifetime of the output in the process. FIG. 2C illustrates a schematic diagram for grouping the activities in FIG. 2A and FIG. 2B in accordance with the output of activities according to an embodiment of the invention. The process in FIG. 2A and FIG. 2B is developed. The group name is the output of activity. The activities in the process are arranged according to the group name. Therefore, the activities having the outputs of same name are arranged in a same group. It is noticed that although the outputs of activities have same name, the outputs are generated by different activities. In other words, the outputs having same name are generated in different stages of the process. For example, the “requirement list” 216 is generated by the “service order” activity 206. Therefore, the “requirement list” 216 represents the items that have not been measured. However, the “requirement list” 215 is generated by the “measured assessment” activity 205. Therefore, the “requirement list” 215 represents the items that have been measured. In other words, although both the “service order” activity 206 and the “measured assessment” activity 205 generate the outputs having same name, “requirement list” , the outputs are generated by different activities and in different stages of the process. For representing the lifetime of the output in the process, the activities having the outputs of same name are arranged in a same group. Both the “service order” activity 206 and the “measured assessment” activity 205 generate the “requirement list” 215 and 216 that have a same name but are generated in different stage of the process. Therefore, the “service order” activity 206 and the “measured assessment” activity 205 are arranged in a same group of the “requirement list” s 215 and 216. The “quotation” 214 is only generated by the “quotation of price” activity 204. Therefore, only the “quotation of price” activity 204 is arranged in the group of the “quotation” 214. Both the “confirming completion of construction” sub-activity 2031 and the “performing construction” sub-activity 2032 generate the “schedule” 2132 and 213 that have same name but are generated in different stage of the process. Therefore, the “confirming completion of construction” sub-activity 2031 and the “performing construction” sub-activity 2032 are arranged in a same group of the “schedule” 2132 and 213. The rest may be deduced by analogy.

On the other hand, FIG. 3C illustrates a schematic diagram for grouping the activities in FIG. 3A and FIG. 3B in accordance with the output of activities according to an embodiment of the invention. All the “writing course information” sub-activity 3054, the “finding teachers” sub-activity 3053, the “arranging course time and place” sub-activity 3052 and the “announcing course” sub-activity 3051 generate the “course information” 3154, 3153, 3152 and 3151 that have a same name but are generated in different stage of the process. Therefore, the “writing course information” sub-activity 3054, the “finding teachers” sub-activity 3053, the “arranging course time and place” sub-activity 3052 and the “announcing course” sub-activity 3051 are arranged in a same group of the “course information” 3154, 3153, 3152 and 3151. Both the “registering” activity 304 and the “paying” activity 303 generate the “registering form” 314 and 313 that have same name but are generated in different stage of the process. Therefore, the “registering” activity 304 and the “paying” activity 303 are arranged in a same group of the “registering form” 314 and 313. The rest may be deduced by analogy.

After the activities are arranged in groups, the step 106 is performed to assign parties or people to be responsible to the activities. That is, the activities are assigned to relevant parties or people in an enterprise in accordance with their rights and responsibilities. FIG. 2D illustrates a schematic diagram for assigning the activities to relevant parties or people in an enterprise in accordance with their rights and responsibilities according to an embodiment of the invention. According to the output and the characteristic of activity, relevant parties, systems or people are assigned to specific activities. For example, all the “service order” activity 206, the “scheduling” sub-activity 2033 and the “customer acceptance” activity 202 are about service work, a customer service department 220 is assigned to be responsible to these activities and sub-activities. The “measured assessment” activity 205, the “performing construction” sub-activity 2032 and the “confirming completion of construction” sub-activity 2031 are about construction work, a construction department 221 is assigned to be responsible to these activities and sub-activities. The “paying” activity 201 is about financial work, an accounting department 223 is assigned to be responsible to the activity. The rest may be deduced by analogy.

In another embodiment, FIG. 3D illustrates a schematic diagram for assigning the activities to relevant parties in an enterprise in accordance with their rights and responsibilities according to an embodiment of the invention. The “arranging course time and place” sub-activity 3052 and the “finding teachers” sub-activity 3053 needs to communicate with other people, a public relations department 321 is assigned to be responsible to these sub-activities. The “registering” activity 304, the “attending course” activity 302 and the “tracing attendance” activity 301 are about service work, a customer service department 322 is assigned to be responsible to these activities. The rest may be deduced by analogy. However, it is noticed that the claimed invention does not be limited by the above assigning method. In another embodiment, different assigning method can be used in the claimed invention.

After the parties are assigned to be responsible to the activities and sub-activities, the step 107 is performed to group the activities and sub-activities according to the parties to clear represent the responsible parties. FIG. 2E illustrates a schematic diagram for grouping the activities in FIG. 2D in accordance with the relevant parties according to an embodiment of the invention. The group name is the name of the responsible party. The activity in the process is arranged according to the responsible party. Therefore, the activities having the same responsible party are arranged in a same group. For example, the customer service department 220 is responsible to the “service order” activity 206, the “scheduling” sub-activity 2033 and the “customer acceptance” activity 202, these activities and sub-activities are arranged in a same group of customer service department 220. The construction department 221 is responsible to the “measured assessment” activity 205, the “performing construction” sub-activity 2032 and the “confirming completion of construction” sub-activity 2031, these activities and sub-activities are arranged in a same group of construction department 221. The rest may be deduced by analogy.

In another embodiment, FIG. 3E illustrates a schematic diagram for grouping the activities in FIG. 3D in accordance with the relevant parties according to an embodiment of the invention. The relationship department 321 is responsible to the “arranging course time and place” sub-activity 3052 and the “finding teachers” sub-activity 3053, these sub-activities are arranged in a same group of relationship department 321. The service department 321 is responsible to the “registering” activity 304, the “attending course” activity 302 and the “tracing attendance” activity 301, these activities are arranged in a same group of the customer service department 321. The rest may be deduced by analogy.

Accordingly, in the present invention, a final output of the process is set as a deduction starting point. Activities relevant to a process are sequentially deduced from the deduction starting point, to form the process. Because the activities are deduced from the final output of the process, these activities are very related to generate the final output. Therefore, the necessary of optimizing the process is reduced.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for process modeling, comprising:
setting a final output of a process as a key artifact; and
generating a plurality of activities sequentially according to the key artifact, wherein the key artifact is a starting point to sequentially generate the activities to form the process.

2. The method of claim 1, further comprising:
determining the activities whether need to be decomposed or not; and
when one of the activities needs to be decomposed, the one of the activities is decomposed to form a sub-process;
wherein the sub-process replaces the one of the activities in the process.

3. The method of claim 2, further comprising:
setting an output of the one of the activities as a key artifact; and
generating a plurality of sub-activities sequentially according to the key artifact to form the sub-process,
wherein the key artifact is a starting point, the sub-activities are sequentially generate from the key artifact to form the sub-process.

4. The method of claim 3, further comprising:
generating a process requirement description according to the key artifact; and
generating a plurality of sub-activities sequentially according to the process requirement description.

5. The method of claim 3, wherein each of the activities generates a corresponding output.

6. The method of claim 5, further comprising:
grouping the activities according to the outputs.

7. The method of claim 5, wherein the output of each of the activities is used as an input of next activity, the next activity generates a corresponding output according to the input.

8. The method of claim 6, further comprising:
assigning the activities to relevant parties.

9. The method of claim 8, further comprising:
grouping the activities according to the relevant parties.

10. The method of claim 1, further comprising:
generating a process requirement description according to the key artifact; and
generating the activities sequentially according to the process requirement description.

11. A method for process modeling, comprising:
setting a final output of a process as a key artifact;
generating a plurality of activities sequentially according to the key artifact, wherein the key artifact is a starting point to sequentially generate the activities to form a process, wherein each of the activities generates a corresponding output;
grouping the activities according to the outputs;
assigning the activities to relevant parties; and
grouping the activities according to the relevant parties.

12. The method of claim 11, further comprising:
generating a process requirement description according to the key artifact; and
generating the activities sequentially according to the process requirement description.

13. The method of claim 11, further comprising:
determining the activities whether need to be decomposed or not; and
when one of the activities needs to be decomposed, the one of the activities is decomposed to form a sub-process;
wherein the sub-process replaces the one of the activities in the process.

14. The method of claim 12, further comprising:
setting an output of the one of the activities as a key artifact; and
generating a plurality of sub-activities sequentially according to the key artifact to form the sub-process,
wherein the key artifact is a starting point to sequentially generate the sub-activities to form the sub-process.

15. A non-transitory computer readable storage medium with a computer program to execute a method for process modeling, the method comprising:
setting a final output of a process as a key artifact; and
generating a plurality of activities sequentially according to the key artifact, wherein the key artifact is a starting point to sequentially generate the activities to form the process.
